(19) United States
(12) Patent Application Publication
(10) Pub. No.: US 2022/0005091 A1
(43) Pub. Date: Jan. 6, 2022

(54) PRODUCT LISTING PROTECTION AND REPRICING SYSTEMS AND METHODS

(71) Applicant: Bruce Zak, Oxford, MI (US)

(72) Inventor: Bruce Zak, Oxford, MI (US)

(21) Appl. No.: 17/368,618

(22) Filed: Jul. 6, 2021

Related U.S. Application Data
(60) Provisional application No. 63/048,624, filed on Jul. 6, 2020.

(51) Int. Cl. G06Q 30/02; G06Q 30/06; G06F 16/903

(52) U.S. Cl. CPC G06Q 30/0283; G06F 16/90348; G06Q 30/0623; G06Q 30/0242

(57) ABSTRACT

Disclosed herein is a product listing protection system (PLPS) and methods for the automated management of product details information on an online marketplace. The PLPS comprises a listing protection app executed on a processor of a computer system that provides the capability to obtain product detail information from multiple sources on a manual, near real-time, or scheduled basis and determine discrepancies when compared to a product master. The listing protection app can then either automatically take corrective actions to erroneous data, or notify the appropriate user that corrective action needs to be taken. The listing protection app begins by pulling available product data and product order data from marketplaces. Also described is an automated repricing component of the PLPS comprising a repricing app. The repricing app also begins by pulling available product data and product order data and comparing to levels in stock to automatically make repricing adjustments accordingly.

### CROSS REFERENCE TO RELATED APPLICATIONS

This application claims priority to Provisional Patent Application No. 63/048,624 filed Jul. 6, 2020, the entire disclosure of which is hereby incorporated by reference and relied upon.

### BACKGROUND OF THE INVENTION

### Field of the Invention

The invention relates generally to ecommerce, and more particularly to protection of product listings on ecommerce and automatic repricing of product listings on ecommerce.

One of the biggest challenges facing sellers on online marketplaces is that the details of product listings are often contaminated by the online marketplace and/or other sellers (3^{rd} parties). Sellers are often referred to as third party sellers. Some of the marketplaces also actually compete as a seller. This allows them to have price advantage and control over all of the other sellers that participate in the online marketplace.

These entities are typically small business owners that do not have the financial resources for extensive technology and/or support staff. Many sellers are selling thousands of products and it becomes difficult to proactively monitor each product listing for contamination on a regular basis. One example of contamination would be the changing of the quantity of the count or quantity included without updating the price to properly reflect an appropriate price to be charged. The result of this problem is that sellers will either be selling the product at a loss and/or receiving negative feedback from the buyer because the buyer did not receive the quantity of the product they anticipated. Unfortunately, this is a losing situation for the seller in either situation.

What is needed is a system and methods for the automated management of product details information on an online marketplace so that accurate product details and pricing are reflected to the consumer.

Another challenge in ecommerce is the enormous time involved with adjusting pricing based on a variety of factors. What is needed is a system and methods for the automated repricing of products.

### SUMMARY OF THE INVENTION

Disclosed herein is a product listing protection system (PLPS) and method (collectively the “system”) for the automated management of product details and pricing information on an online marketplace. The system provides the capability to obtain product detail information from multiple external sources (external data) in the ecommerce marketplace on a manual, real-time, or scheduled basis (i.e. daily, hourly, etc.) and determine discrepancies from a seller's product master (internal data typically in the form of a table) and either automatically take corrective actions, or notify the appropriate user that corrective action needs to be taken.

In one form, a PLPS comprises an automated product repricing component.

In one form, a PLPS utilizes external data which is data obtained from the ecommerce marketplace. External data can become contaminated or corrupted by either the marketplace or another third-party seller selling the same product.

In one form, external data comprises external product order data and external product data.

In one form, a PLPS utilizes internal data stored within a product master. The product master comprises the authentic and verified information that is provided by one or more manufacturers by batch feed or load for their products. This information comprises all the manufacturer supported product attributes although not all are supported on a particular marketplace. Internal data comprises one or more of internal product order data and data associated with the product (internal product data).

In one form, a PLPS utilizes one or more tables called a product master in which one or more of the internal product order data and internal product data are arranged.

In one form, a product master in a PLPS utilizes one or more of the following product order data related to a product: order identification number, orderitemid (a product identifier), purchase date, payment date, buyer email, buyer name, buyer phone number, product SKU, product name, quantity purchased, shipping service level, recipient name, 1^{st} ship address, 2^{nd} ship address, 3^{rd} ship address, ship to city, ship to state, ship to postal code, ship to country.

In one form, a product master in a PLPS utilizes one or more of the following product data related to a product: product identification, product name, default picture identification, viewable price, product comments, comments created by, comments created date, updated date/time, update by, dealer identification, make identification, short description, long description, product year, SKU number, stock number, price, viewable image of product, weight, UPC code, and WH location (warehouse location).

In one form, a PLPS utilizes external data collected daily via automated processes during off business hours to allow for a sufficient time window for data pull and processing.

In one form, a PLPS pulls (collects) external product data and external product order data by making a request for one or more files that contain the external product data and/or external product sales data (also known as product order data). The file format is typically a text file (i.e. tab delimited, csv, etc.) or in a binary format such as Microsoft Excel but is not limited to these types. Once the request is submitted there is a variable time delay for the generation of the requested file(s). Upon completion, the external product data and/or external product order data files(s) are downloaded to a secure storage area for processing and optionally scanned for viruses and other data inconsistencies.

In one form, a PLPS utilizes external data pulled daily via web services which typically use but are not limited to one of an xml interface and application programming interfaces (APIs) to request the file or the data records. With this type of implementation, this external data is assembled into a complete listing of at least one of product data and product order data.

In one form, a PLPS utilizes external data pulled daily via a page scraping approach for marketplaces that do not provide access to this information. Automated processes will match attributes needed on one or more pages to fulfill the requirements of the external product data and/or external product order data.

In one form, a PLPS performs a comparison of external data versus internal data analyzing for one or more of the following discrepancies: product title (name), the price, the count (1 count, 2 ct, 3 ct, etc.), package quantity (i.e., pack of 3, pack of 6, etc.) and the product description. These attributes can be contaminated in their corresponding individual attributes, or they can be packed into other attributes such as the product title and/or product description, etc. In other embodiments there can be variations in the count, pack, price, key product features, product title and product description.

In one form, a PLPS analyzes the price of an individual item ensuring that it is above a defined threshold that is established by an administrator for the seller. This is a metric to ensure profitability for the seller and varies based on size, overhead, product type, etc.

In one form, data from a PLPS is exported via a secure portal for small businesses with a small number of products (i.e., less than 100).

In one form, data from a PLPS are exported via web services that are provided and communicated with via an xml interface or application programming interfaces (APIs).

In one form, data exported from a PLPS is retrieved via text file in a tab delimited or comma delimited format.

In one form, a PLPS comprises an add on feature to automatically update corrected product listings for various online marketplaces.

In one form, a PLPS with a feature to automatically update correct product listings include corrections to the product title, price, quantity, count, pack, key product features, product description etc. This function can be done via one or more of: an automated upload feature, web service, and API.

In one form, a PLPS is provided in a subscription-based model. In this model, users pay or promise to pay in predetermined intervals to utilize the PLPS.

In one form, a PLPS is installed in-house.

In one form, a PLPS is available via the cloud for maximum flexibility for customers.

In one form, a PLPS identifies exceptions. Exceptions are contaminated product listings that are not able to be corrected via automated computer rules or processes. User intervention is utilized to correct exceptions. In one embodiment, the user activates the processing of the corrected exceptions to the online marketplaces. In another embodiment, the corrected exceptions are automatically processed to the online marketplaces.

In one form, a PLPS comprises a feature that automatically removes offering the contaminated products until the necessary user intervention to correct an exception can be completed. This avoids a contaminated sale being completed which leads to a bad customer experience and potentially a negative review or feedback.

In one form, a PLPS performs a decode step which breaks down the product title or product description to identify contamination of count, pack and other discrepancies within the product title or product description attributes. There are many key tags that can be searched for within these attributes and this is driven by a dynamic data dictionary as the key tags are constantly changing and evolving by the entities that are performing the contamination.

In one form, a PLPS repeats an algorithmic loop as it completes a loop for each active marketplace (i.e., Amazon, Ebay, Walmart, etc.)

In one form, a PLPS comprises a firewall providing security for the Internet for an entity. In this scenario the seller wants to maintain their PLPS solution in-house.

In one form, a PLPS operates the listing protection and product master based on the internet.

In one form, a PLPS operates through the cloud utilizing cloud services such as AWS, Microsoft, etc.

In one form, a PLPS utilizes user facing options and/or administrator facing options.

In one form, a PLPS comprises a separate administrator computing system through which an administrator of the PLPS interfaces with the system.

In one form, a PLPS is configured for an administrator to interface with the PLPS through the same computer running the listing protection application.

In one form, a PLPS comprises exception queue processing to manage manual edits and/or updates as a user facing option.

In one form, a PLPS comprises a maintenance interface to set threshold parameters as an administrator facing option.

In one form, a PLPS is installed on a computing system located in-house.

In one form, a PLPS operates through a cloud.

In one form, a PLPS operates on a computing system located in-house and through a cloud.

In one form, a PLPS comprises a listing protection app and a product master on separate computers. This separation can provide more security and redundancy, however, may require additional maintenance and associated costs.

In one form, a PLPS comprises a listing protection app and a product master app on the same computer. In one form, the product master app is a dependent component of the PLPS for use in comparison of internal and external data.

In one form, the product master app is absent of the PLPS.

In one form, the product master app comprises a living database that is routinely updated from the manufacturers of the product in the marketplace (i.e. model year, design changes, product updates, recall changes or cancellations, etc.).

In one form, the product master app can reside in one or more locations on one or more servers and on one or more databases.

In one form, two or more users of a PLPS are housed in the same location or different locations.

In one form, the PLPS and a repricing system can operate independently without the other or can operate simultaneously. In addition, in some embodiments the PLPS and repricing system are located on the same computing device, whereas in other embodiments, the PLPS and repricing systems are located on different computing devices. In some embodiments, the PLPS and repricing system are utilized in the same location, whereas in other embodiments they are utilized in distanced locations in for example, other cities, states, or countries.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts one embodiment of a product listing protection system (PLPS);

FIG. 2 depicts one embodiment of a product listing protection system;

FIG. 3 depicts one embodiment of steps of an algorithm operable in a listing protection app of a product listing protection system;

FIG. 4 illustrates one embodiment of steps of an algorithm operable for automated repricing in ecommerce as part of a product listing protection system;

FIG. 5 depicts one embodiment of computer architecture that is utilized to interface with a PLPS and/or repricing system;

FIG. 6 depicts examples of a variety of computing devices that can be utilized in a product listing protection system;

FIG. 7 depicts one embodiment of a user facing display illustrating a listing of exceptions displayed on a user's screen;

FIG. 8 depicts one embodiment of a user facing display illustrating listing exceptions detail displayed on a user's screen.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100A, 100B, 100C). Numerals without letters (i.e., 100, 102 etc.) represent standard elements utilized across various embodiments. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

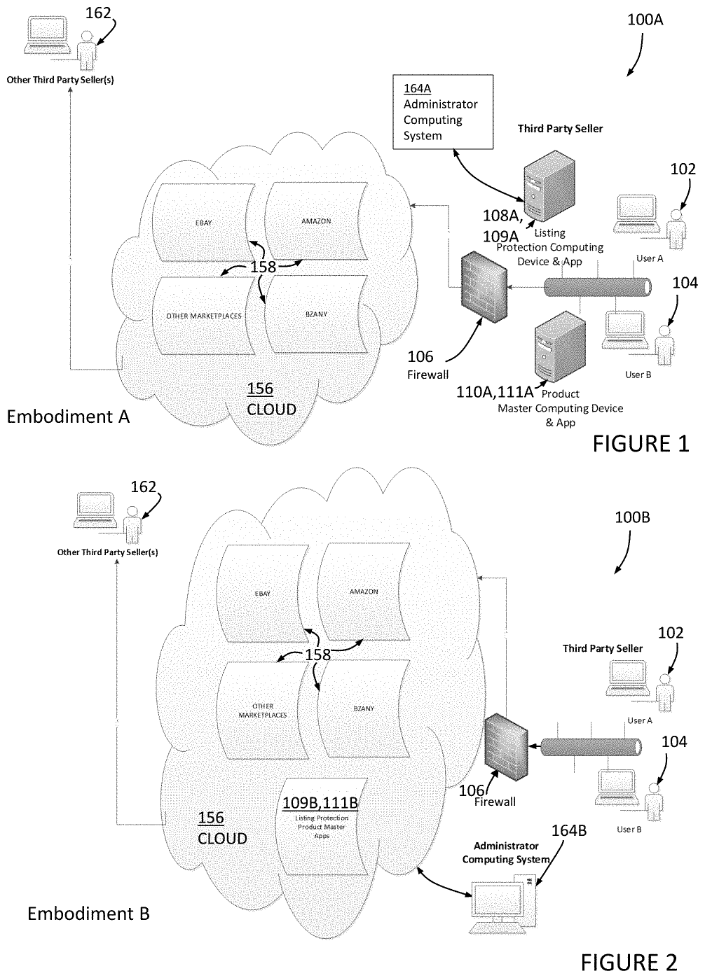

FIG. 1 is a diagram depicting one embodiment of a product listing protection system (PLPS) 100A operable for the automated management of product details information on an online marketplace. The illustrated system and others illustrated herein provide the capability to obtain product detail information (external data) from multiple sources on a scheduled basis (i.e. daily, hourly, etc.) and determine discrepancies between the external data and internal data from a product master. The system then either automatically takes corrective actions to correct the external data or notifies the appropriate user that corrective action needs to be taken. In this embodiment (FIG. 1), one or more users (i.e., user A, 102, and user B, 104) of the system are situated behind a firewall 106 of the PLPS thereby providing security for the internet for an entity. Here a PLPS computer system 108A is located in-house of a business that sells goods by ecommerce.

In this embodiment, the PLPS 100A utilizes internal data stored on a product master 150 in memory 122 of a product master computing device 110A. The product master 150 comprises one or more internal product order data 152 and data associated with the product known as internal product data 154. Product order data, whether internal or external, comprises one or more of the following order data related to a product: order identification number, orderitemid, purchase date, payment date, buyer email, buyer name, buyer phone number, product SKU, product name, quantity purchased, shipping service level, recipient name, 1^{st} ship address, 2^{nd} ship address, 3^{rd} ship address, ship to city, ship to state, ship to postal code, ship to country. In addition, the PLPS 100A utilizes one or more of the following product data (internal or external) related to a product: product identification, product name, default picture identification, viewable price, product comments, comments created by, comments created date, updated date/time, update by, dealer identification, make identification, short description, long description, product year, SKU number, stock number, price, viewable image of product, weight, UPC code, and WH location (i.e. warehouse location). In preferred embodiments, the PLPS 100A, 100B utilizes data pulled daily via automated processes during off business hours to allow for a sufficient time window for data pull and processing. Users, with protection of a PLPS 100A, interface through the cloud 156 with common ecommerce sites 158 such as but not limited to EBAY, AMAZON, BZANY, and other ecommerce marketplaces. A ‘common’ ecommerce site will have more than 10 customers although this number can vary. Other third-party sellers 162 also interface through the cloud 156 with these common ecommerce sites. In some embodiments, other third-party users 162 can utilize the PLPS for listing protection and repricing as needed.

FIG. 2 is a diagram depicting yet another embodiment of a product listing protection system (PLPS) 100B operable for the automated management of product details information on an online marketplace. In this embodiment, one or more users (i.e., user A, 102 and user B, 104 utilizing the PLPS) are also situated behind a firewall 106 of the PLPS 100B. This system is much like the PLPS 100A of FIG. 1 with the exception of the listing protection app 109B and product master app 111B interfacing through the internet cloud 156 as depicted. An administrator computing system 164B is operable to interface with the listing protection app 109B and product master app 111B. This can be done through at least one of: the cloud 156 (i.e., FIG. 2) and local computing systems (i.e., FIG. 1) such as administrator computing system 164A. A PLPS 100B operating through the cloud 156 can utilize cloud services such as AWS, Microsoft, etc.

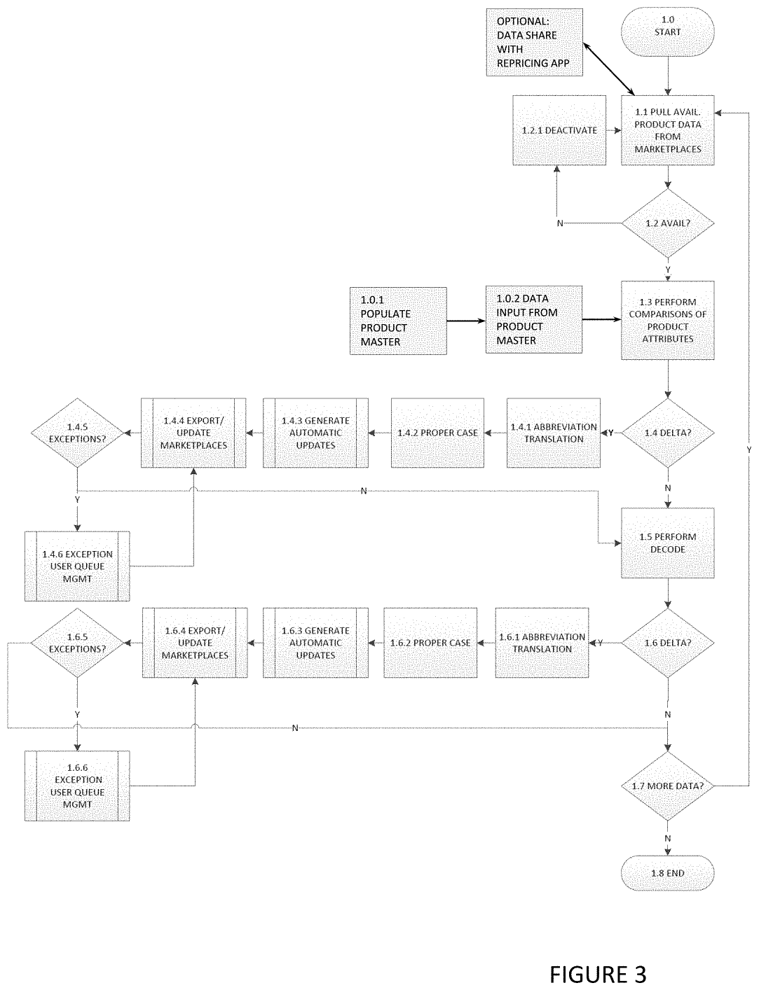

FIG. 3 illustrates one embodiment of an algorithm used in a listing protection app 109A, 109B as part of a product listing protection system (PLPS) 100A, 100B. The listing protection app 109A, 109B, executes these instructions on a computer processor 120 of a PLPS computer system 108A utilizing memory 122 and local storage 128 as needed or can operate from a cloud based PLPS computer system 108B as discussed earlier. FIG. 3 also depicts the interface with a product master app 111A. The algorithm in a PLPS process is started (step 1.0). At step 1.0.1, a product master 150 (typically in the form of a table) associated with a product master app 111A, 111B and stored on computer memory/storage (i.e. product master computing device 110A or cloud device) is populated with verified information by one or more product manufacturers by batch feed/load for their products. Internal data on the product master 150 is then provided as needed to the listing protection app 109 (step 1.0.2). External data (i.e. external product order data 153, external product data 155) is pulled (collected) from available common ecommerce sites 158 such as AMAZON for example (step 1.1). If this marketplace external product data 155 and/or external product order data 153 is available (step 1.2), it is compared to internal product data 154 and internal product order data 152 input from the product master 150 on the product master computing device 110A, or equivalent device in the cloud. Collecting the external data is done by making a request for one or more files from a memory 122 device that contain the product data and/or product order data. The file format used is typically a text file (i.e., tab delimited, csv, etc.) or in a binary format such as Microsoft Excel but is not limited to these types. Once the external data request is submitted there is a variable time delay for the generation of the requested file(s). Upon completion, the external product data 155 and/or external product order data 153 files(s) are downloaded to a secure storage area such as local storage 128 for processing by a computer processor 120 and optionally scanned for viruses and other data inconsistencies. If the marketplace external data is not available, the PLPS listing protection app 109 repeats pulling available external product data 155 from the ecommerce marketplaces (step 1.1) until the marketplace data is obtained or the process is deactivated until restarted (step 1.2.1).

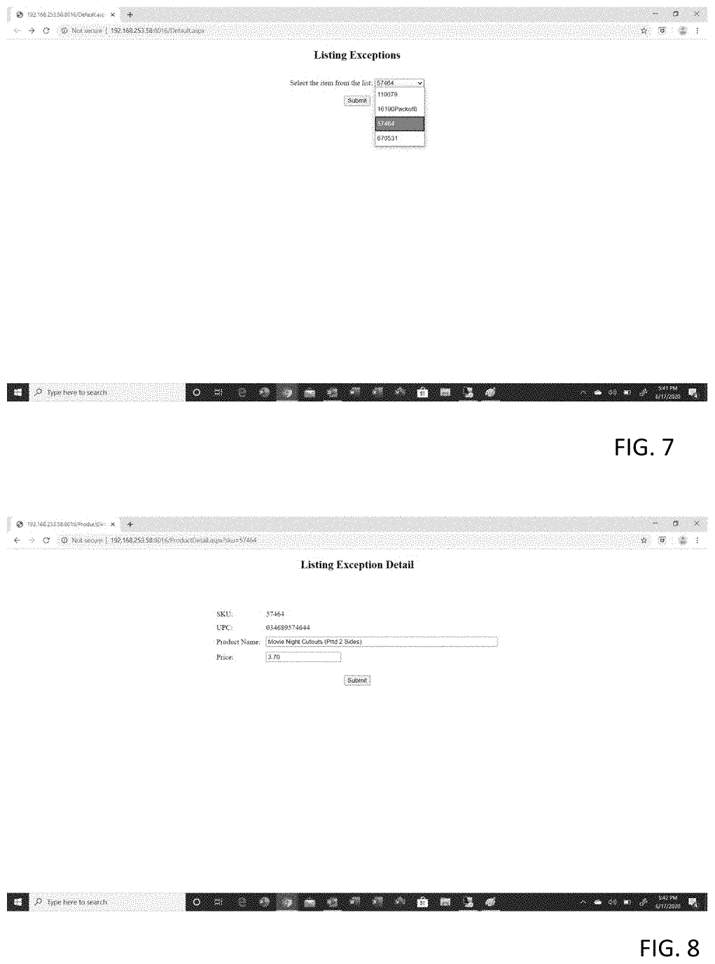

In the event that external product data 155 is available, the PLPS listing protection app 109 executes instructions in the processor to recognize differences between the respective set of ecommerce marketplace external product data 155 and external product order data 153, and the set of internal product data 154 and/or internal product order data 152 (step 1.3) by executing analysis of the data in the computer processor 120 using computer storage 128 and memory 122. One example of data discrepancy is price. If no differences exist between the internal and external data sets, the operations continue to perform a decode (step 1.5) as discussed below. If differences exist between the data sets (step 1.4), a data set abbreviation translation is performed (step 1.4.1). In this step, a pattern search for abbreviations that have been identified in the data dictionary are replaced with the full proper text name. The translation can be completed on all product attributes including but not limited to title, product name, product description, etc. The abbreviation translation step is followed by a proper case translation (step 1.4.2) which performs a search for words or phrases that should be uppercased or contrarily lowercased. The translation can be completed on all product attributes including but not limited to title, product name, product description, etc. Once complete, updates to the ecommerce marketplace data are then automatically generated (step 1.4.3) and the ecommerce marketplace data is exported and updated (step 1.4.4). Exceptions, contaminated product listings that are not able to be corrected via automated rules or processes are identified (step 1.4.5) and output to the user via a listing of exceptions displayed on a user's screen as depicted in FIG. 7. Listing exceptions detail are then displayed on the user's screen (FIG. 8) whereby fields are available to manually enter in override fields such as price during an exception user que management step (step 1.4.6). These manually entered values in the override fields are again exported to update the ecommerce marketplace data in a repeat of step 1.4.4. In the event there are no exceptions, the process continues to a decode operation as described below to compare values. In some embodiments, the PLPS comprises a feature that automatically shuts off the availability of contaminated products until the necessary user intervention to correct an exception can be completed. This avoids a contaminated sale being completed which leads to a bad customer experience and potentially a negative review or feedback. This is noted at step 1.4.5 and 1.4.6 and later at 1.6.5 and 1.6.6.

A decode operation comparing values between the product master (internal) product data and/or product order data versus the (external) ecommerce marketplace data is performed (step 1.5) and differences between these values are recognized (step 1.6). The decode operation breaks down the product title or product description to identify contamination of count, pack and other discrepancies within the product title or product description attributes. There are many key tags that are searched for within these attributes and this is driven by a dynamic data dictionary as the key tags are constantly changing and evolving by the entities that are performing the contamination. The requirement for more data is assessed (step 1.7). If no differences exist between the data sets, the operations continue to seek more data from the ecommerce marketplace (step 1.1). If differences exist between the data sets, a data set abbreviation translation is performed (step 1.6.1). In this step, a pattern search for abbreviations that have been identified in the data dictionary are replaced with the full proper text name. The translation can be completed on all product attributes including but not limited to title, product name, product description, etc. The abbreviation translation step is followed by a proper case translation (step 1.6.2) which performs a search for words or phrases that should be uppercased or contrarily lowercased. The translation can be completed on all product attributes including but not limited to title, product name, product description, etc. Once complete, updates to the ecommerce marketplace data (i.e., external product order data 153, external product data 155) are then automatically generated (step 1.6.3) and the ecommerce marketplace data is exported and updated (step 1.6.4). Exceptions, contaminated product listings that are not able to be corrected via automated rules or processes are again identified (step 1.6.5) and output to the user via a listing of exceptions displayed on a user's screen (FIG. 7). Here, the PLPS comprises exception que processing to manage manual edits and/or updates as a user facing option. Listing exceptions detail are displayed on the user's screen (FIG. 8) whereby fields are available to manually enter in override fields such as price during an exception user que management step (step 1.6.6) which again is then exported to update the external data at the ecommerce marketplace (step 1.6.4). In the event there are no exceptions, the process continues to seek more data from the ecommerce marketplace (step 1.7) to again pull more data from the ecommerce marketplace (step 1.1). Alternatively, the process can be ended (step 1.8). The PLPS can repeat an algorithmic loop as it completes a loop of common ecommerce sites 158 (i.e., AMAZON, EBAY, WALMART, etc.)

In some embodiments, the PLPS 100A, 100B utilizes external data pulled intermittently (i.e., daily, but can be adjusted for other intervals) via web services which typically use but are not limited to one of an xml interface and application programming interfaces (APIs) to request the file or the data records. With this type of implementation, the data is assembled into a complete listing of at least one of external product data 155 and external product order data 153. Alternatively, PLPS utilizes data pulled daily or using other time frames via a page scraping approach for marketplaces that do not provide access to this information. These automated processes will match attributes needed on one or more pages to fulfill the requirements of the product data and/or product order data.

At steps such as 1.3, routines in a PLPS listing protection app 109 performs a comparison of product data analyzing for one or more of the following discrepancies: product title (name), the price, the count (1 count, 2 ct, 3 ct, etc.), package quantity (i.e., pack of 3, pack of 6, etc.) and the product description. These attributes can be contaminated in their corresponding individual attributes, or they can be packed into other attributes such as the product title and/or product description, etc. In other embodiments there can be other variations in the count, pack, price, key product features, product title and product description. For example, in some embodiments, algorithms in a PLPS listing protection app 109 analyze the price of an individual item ensuring that it is above a defined threshold that is established by an administrator for the seller. This is a key metric to ensure profitability for the seller and varies based on size, overhead, product type, etc.

In some embodiments, data from a PLPS is exported via a secure portal for small businesses with a small number of products (i.e., less than 100). In other embodiments, data from a PLPS are exported via web services that are provided and communicated via an xml interface or application programming interfaces (APIs). Data exported from a PLPS is retrieved via text file in a tab delimited or comma delimited format.

In some embodiments, a PLPS comprises an add on feature to automatically update corrected product listings for various online marketplaces. For example, these product listings include corrections to one or more of the product title, product description, key product features, price, quantity, count, pack, etc. This function can be done via one or more of: an automated upload feature, web service, and API. In some embodiments, a PLPS is provided as a service in a subscription-based model. In some embodiments, a PLPS comprises a maintenance interface to set threshold parameters as an administrator facing option.

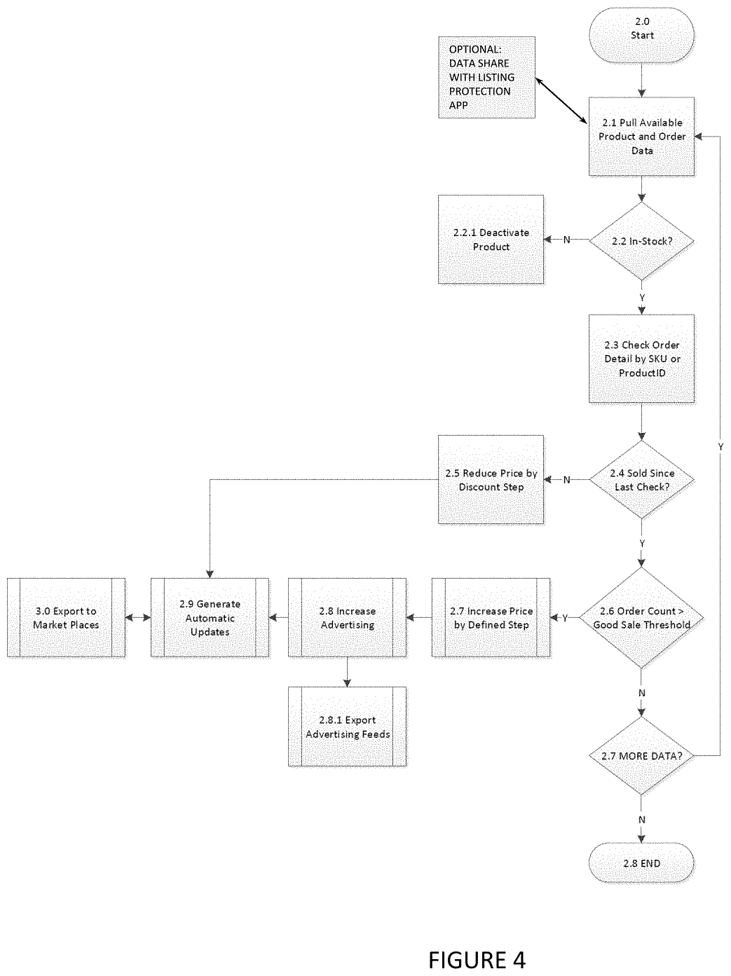

In some embodiments, the PLPS comprises an automated repricing component utilizing a repricing app 166. FIG. 4 illustrates one embodiment of steps of an algorithm as used in a repricing app 166 and operable for automated repricing in ecommerce. The repricing app 166 and algorithm can be operated in computing configurations as described previously in FIGS. 1 and 2 although it is not limited to these configurations. In some embodiments, a computing device such as used for the listing protection (PLPS) computing device 108A can also simultaneously be utilized to run a repricing app 166, however the repricing app 166 can reside at other locations and on other computing devices. As illustrated in FIG. 4, the automated repricing process is started (step 2.0) by pulling (collecting) available external product data 155 and external product order data 153 from the ecommerce marketplaces (step 2.1). Note that this collection step can be completed in conjunction with (step 1.1) and therefore processes in the listing protection app 109 and repricing app 166 can be interdependent and share this information as illustrated in FIGS. 3 and 4. A check is then made to determine if the associated products are in stock (step 2.2). Products that are not in stock are deactivated from further sales (step 2.2.1). In stock product order details are checked by at least one of their associated SKU or product ID (step 2.3). A check is then made to determine if any of the product has been sold since the last check (step 2.4). If none have been sold, an operation is run to reduce the price of the product by a defined discount step (step 2.5). Automatic updates of the reduced product pricing are generated (step 2.9) and exported to the ecommerce marketplaces (step 3.0) to update the external data. If the check at step 2.4 indicates product has been sold, an order count is made and compared to predefined thresholds for ‘good sales’ (step 2.6). Those products meeting the ‘good sale’ thresholds are increased in price by an increase by defined step (step 2.7). In addition, those products meeting a good sale threshold can automatically receive a boost in advertising (step 2.8) to further take advantage of the well selling product. This boost can be completed by the exporting of advertising feeds (step 2.8.1) which automatically generates additions and changes of product attributes (including but not limited to title, product name, product description, pricing, etc.) to advertising engines. Advertising engines can include but are not limited to Google, Bing, Yahoo, Ebay, Amazon and others. This may be a full product catalog feed or just incremental.

Following the increase advertising step, automatic updates of the increased product pricing are again generated (step 2.9) and these revised pricings are exported to the ecommerce marketplaces (step 3.0). Alternatively, if an order count is made and does not meet predefined thresholds for ‘good sales’, more data is sought (step 2.7) and available product data and order data are once again pulled during a recycle step (step 2.1). In the event that more data is unnecessary, the routine can end (step 2.8).

FIGS. 1 and 2 illustrate examples of computing devices utilized in PLPS and repricing systems. The PLPS and repricing systems, however, are not limited to the computing devices shown. Additional examples include the computing devices that are illustrated in FIG. 6. This includes any one or more of: a PDA/smart phone 136, mobile computers such as laptops 138, a tablet 140, a personal computer 144, a server 142, a virtual personal computer 146, and a computer terminal 148. These devices can be utilized by users of the PLPS and repricing systems as well as administrators to interact and perform various computing procedures. The computing devices can function as a server, a client, or any other computing entity. Computing devices within PLPS and repricing systems can perform various monitoring functions as discussed herein and can execute one or more application programs, such as application programs described herein. The PLPS and the repricing systems can include one or more administrator computing system 164 for managing administrator facing features of the system. Any one or more of the computing devices can include storage devices.

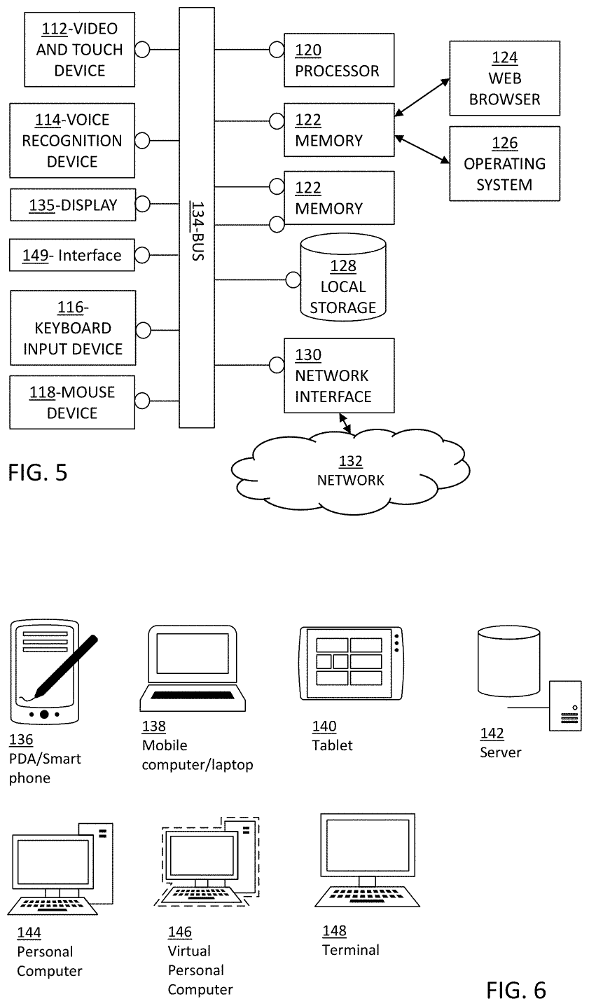

As illustrated by example and not limitation in FIG. 5, computer architecture supporting a PLPS and/or repricing system can include one or more processor(s) 120, one or more memory device(s) 122, one or more network interface(s) 130 to interface with a network 132, one or more local storage 128 or remote mass storage device(s), one or more of Input/Output (I/O) device(s) such as a mouse 118 and keyboard input device 116 and voice recognition 114 and video and touch device 112, and one or more display 135, all of which are coupled to a bus 134. The displays are utilized to display user and administrator facing options such as for example, those illustrated in FIGS. 7 and 8. These user and administrator options are selectable by the user and administrators through use of the I/O devices. Processor(s) 120 include one or more processors and controllers that execute instructions from the PLPS listing protection app 109 and/or automated repricing apps 166 stored in memory device(s) 122 and mass storage device(s) (i.e. local storage 128). Processor(s) may also include various types of computer-readable media, such as cache memory.

Memory device(s) utilized in the computing systems described herein may include one or more various computer-readable media, such as volatile memory (e.g., random access memory (RAM)) and nonvolatile memory (e.g., read-only memory (ROM)). Memory device(s) may also include rewritable ROM, such as flash memory. A memory device may also be in the form of mass storage device(s) including various computer readable media, such as magnetic tapes, magnetic disks, optical disks, solid-state memory (e.g., flash memory), and so forth. Mass storage devices may be in the form of a hard disk drive to serve various computing devices. Various drives may also be included in mass storage device(s) to enable reading from and/or writing to the various computer readable media. Mass storage device(s) may include removable media and/or non-removable media.

Memory may be used for storing an operating system 126, application programs such as web browsers 124, other program modules, and program data such as data related to the listing protection app 109 and repricing apps 166 disclosed herein. The apps described herein operate according to the resident operating system. I/O device(s) include one or more of various devices that allow data and other information to be input to and retrieved from computing device(s). Example I/O device(s) include one or more of; cursor control devices, keyboards, keypads, microphones, monitors and other display devices, speakers, printers, network interface cards, modems, lenses, CCDs and other image capture devices, and the like.

Display devices include any type of device capable of displaying information to one or more users of a computing device in communication with the PLPS listing protection app 109 and/or repricing apps 166. Examples of display devices include a monitor, display terminal, video projection device, and the like. A monitor and other types of display devices may also be connected to a system bus 134 via an interface 149, such as a video interface. A graphics interface may also be connected to a system bus. One or more graphics processing units (GPUs) may communicate with a graphics interface. In this regard, GPUs generally include on-chip memory storage, such as register storage and GPUs communicate with a video memory. GPUs, however, are but one example of a coprocessor and thus a variety of co-processing devices may be included in a computer. In addition to a monitor, computers may also include other peripheral output devices such as speakers and printer, which may be connected through an output peripheral interface.

A bus 134 allows processor(s) 120, memory device(s) 122, interface(s) 149, mass/local storage device(s) 128, and I/O device(s) to communicate with one another, as well as other devices and components coupled to the bus. Bus represents one or more of several types of bus structures including a memory bus and memory controller, a peripheral bus, a system bus, and a local bus using any variety of bus architectures. By way of example and not limitation, these may include PCI bus, IEEE 1394 bus, USB bus, ISA bus, MCA bus, EISA bus, and VESA local bus.

One of ordinary skill in the art can appreciate that a computer or other client device can be deployed as part of a computer network 134. In this regard, the present invention pertains to any computer system having any number of memory and storage units, and any number of applications and processes occurring across any number of storage units and volumes. The present invention may apply to an environment with server computers and client computers deployed in a network environment, having one or more of remote and local storage. The present invention may also apply to a standalone computing device, having programming language functionality, interpretation, and execution capabilities.

Interface(s) 149 include various interfaces that allow any computing devices to interact with other systems, devices, and computing environments. Example interface(s) include any number of different network interfaces, such as interfaces to local area networks (LANs), wide area networks (WANs), wireless networks, and the Internet. Other interface(s) include user interface and peripheral device interface. An interface(s) may also include one or more user interface elements. An interface(s) may also include one or more peripheral interfaces such as interfaces for printers, pointing devices (mice, track pad, etc.), keyboards, and the like.

When used in a LAN networking environment, a computer is connected to the LAN through a network interface or adapter. When used in a WAN networking environment, the computer typically includes a modem or other means for establishing communications over the WAN, such as the Internet. A modem, which may be internal or external, may be connected to a system bus via a user input interface, or other appropriate mechanism. In a networked environment, program modules depicted relative to the computer, or portions thereof, may be stored in the remote memory storage device. By way of example and without limitation, remote application programs may reside on a memory device. It will be appreciated that network connections shown are exemplary and other means of establishing a communications link between the computers may be used.

Embodiments can also be implemented in cloud 156 computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

For purposes of illustration, programs and other executable program components are shown herein as discrete blocks, although it is understood that such programs and components may reside at various times in different storage components of a computing device and are executed by processor(s). Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor 120 of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In this specification the PLPS system is not limited to only managing the product attributes identified but rather this is a minimal set of attributes that can be managed, but it can support additional product attributes.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A computer-implemented method in a product listing protection system (PLPS) comprising:
populating a product master with verified internal data associated with products for sale;
collecting by a computer system, external data about said products from one or more common ecommerce sites;
utilizing a computer processor to perform comparisons between said external data and said internal data obtained from said product master; and
making corrections to said external data.

2. The computer implemented method of claim 1 further comprising the step of:
utilizing at least one of a file processing interface and application programming interface to request the external data.

3. The computer implemented method of claim 1 wherein the step of collecting by a computer system, external data about said products from one or more common ecommerce sites further comprises the step of collecting the external data on one of a manual, real-time, and scheduled basis.

4. The computer implemented method of claim 1 wherein the step of collecting external data about said products from one or more common ecommerce sites further comprises the step of:
collecting one or more of external product data and external product order data from a common ecommerce site.

5. The computer implemented method of claim 1 wherein the step of utilizing a computer processor to perform comparisons between said external data and said internal data obtained from said product master further comprises:
utilizing said computer to perform comparisons between external product order data and internal product order data from said product master.

6. The computer implemented method of claim 1 wherein the step of utilizing a computer processor to perform comparisons between said external data and said internal data obtained from said product master further comprises:
utilizing said computer to perform comparisons between external product data and internal product data from said product master.

7. The computer implemented method of claim 1 further comprising the step of:
utilizing a computer to perform an abbreviation translation step comprising a pattern search of the external data for abbreviations that have been identified in a data dictionary and are then replaced with the full proper text name.

8. The computer implemented method of claim 1 further comprising the step of:
utilizing a computer to perform a proper case step comprising a search of the external data for words or phrases that should be uppercased or contrarily lowercased.

9. The computer implemented method of claim 1 further comprising the step of:
utilizing a computer to generate automatic updates to at least one of the external product data and external product order data thereby correcting discrepancies with the product master.

10. The computer implemented method of claim 1 further comprising the step of:
utilizing a computer to export automatic updates with one or more of revised external product data and external product order data to the common ecommerce sites.

11. The computer implemented method of claim 1 further comprising the step of:
utilizing a computer to perform a decode operation that analyzes at least one of product title and product description to identify contamination of one or more of count, pack and other discrepancies within the product title or product description attributes.

12. The computer implemented method of claim 1 further comprising the step of:
utilizing a computer to identify contaminated external data not corrected by one or more automated rules and processes in the PLPS.

13. The computer implemented method of claim 1 further comprising the step of:
utilizing a computer to display on a computer display a listing of exceptions in contaminated product listings.

14. The computer implemented method of claim 1 further comprising the step of:
utilizing a computer to display on a computer display a listing of exceptions in contaminated product listings with fields available to override the exceptions using a computer input device.

15. The computer implemented method of claim 1 further comprising the step of:
utilizing a computer to perform a check to determine if a product has been sold since the last check and reducing the price if no sales have been made since the last check.

16. The computer implemented method of claim 1 further comprising the step of:
utilizing a computer to perform a check and determine if a product has met a good sale threshold and increasing the price of the goods by a defined step if the good sale threshold was met.

17. The computer implemented method of claim 1 further comprising the step of:
utilizing a computer to perform a check and determine if a product has met a good sale threshold and increasing advertising if the good sale threshold was met.

18. The computer implemented method of claim 1 further comprising the step of:
utilizing a computer to export updated pricing to one or more common ecommerce sites.

19. The computer implemented method of claim 1 further comprising the step of:
utilizing a computer to determine if a product is in stock and deactivating products not in stock from further sales on common ecommerce sites.

20. The computer implemented method of claim 1 further comprising the step of:
utilizing a computer to generate automatic updates to correct external data and exporting the updated external data to one or more selected ecommerce websites.
